(19) United States
(12) Patent Application Publication
(10) Pub. No.: US 2022/0080768 A1
(43) Pub. Date: Mar. 17, 2022

(54) BIGOP LEARN AND PLAY, TEMPLATES PRINTED ON EACH SIDE OF THE DRY ERASE BOARD FOR LEARN AND PRACTICE ADDITION, SUBTRACTION AND MULTIPLICATION

(71) Applicant: Bigop Learn and Play LLC, White Plains, NY (US)

(72) Inventors: Santiago Alzate Carmona, White Plains, NY (US); Cinthia Chinchin, White Plains, NY (US)

(21) Appl. No.: 17/018,123

(22) Filed: Sep. 11, 2020

(51) Int. Cl. B43L 1/00; B43L 21/04; G09B 19/02; G09B 1/16

(52) U.S. Cl. CPC B43L 1/008; G09B 1/16; G09B 19/02; B43L 21/04

(57) ABSTRACT

A double-sided portable dry erase board that is lightweight, has unlimited uses and is easy to carry. It is designed for convenient portability, which may cooperate with the memo edition of the body of books for easy storage and practical use. Additionally, the instant device is to provide educational and frequent arithmetic practice when used for addition, subtraction and multiplication utilizing both vertical and horizontal uses. The instant device has a simple pedagogic structure and strong practicality, designed to work with grades K-1 curriculum and beyond.

### FIELD OF INVENTION

The instant application relates to an arithmetic tool with a utility model template of a double-sided portable dry erase board which currently is utilized as a teaching tool.

### BACKGROUND OF THE INVENTION

A dry erase board is a writing plane made of a white sheet metal that has non-pollutants and convenient to use. It is a writing tool that can be repeatedly erased. However, most dry erase boards are single-sided plain whiteboards, whereas the instant device may be utilized as a multipurpose teaching tool for different operations such as basic math and arithmetic practice. A lightweight double-sided dry erase board with multifunctional and interchangeable utility model templates that is easy to carry can provide great benefits as a versatile teaching tool.

### SUMMARY OF INVENTION

The instant device, method and accompanying series of apparatuses, as illustrated herein, are clearly not anticipated, rendered obvious, or even present in any of the prior art mechanisms, either alone or in any combination thereof.

The primary object of the instant device is to provide a utility model double-sided portable dry erase board that is lightweight, has unlimited uses and is easy to carry. It is designed for convenient portability, which may cooperate with the memo edition of the body of books for easy storage and practical use.

Another object of the instant device is to provide educational and frequent arithmetic practice when used for addition, subtraction and multiplication utilizing both vertical and horizontal uses. The instant device has a simple pedagogic structure and strong practicality, designed to work with grades K-1 curriculum and beyond.

The instant device is an inexpensive alternative to paper that can be reused when resolving problems after problems. It also offers a great way for students to participate their lessons individually or in small groups. Parents will be encouraged to have this product to help children with their problem-solving tasks.

The instant device maintains the safety standards for its use and distribution knowing that it will not be scratched or cut with sharp corners or edges, nor is it harmful to the health and well-being of any person.

### BRIEF DESCRIPTION OF THE DRAWINGS

In the drawings:

FIG. 1 illustrates a double-sided portable dry erase board frame in accordance with the invention.

FIG. 2 is a schematic diagram of FIG. 1 illustrating the double-sided portable dry erase board with the front face of a first embodiment of an imprinted utility model template and the back face of a second embodiment of an imprinted utility model template in accordance with the invention.

FIG. 3 is a schematic diagram of FIG. 1 illustrating the double-sided portable dry erase board with the front face of the second embodiment of an imprinted utility model template and the back face of the first embodiment of an imprinted utility model template in accordance with the invention.

FIG. 4 illustrates an apparatus of a dry erase pen in accordance with the invention.

FIG. 5 illustrates an eraser in accordance with the invention.

### DETAILED DESCRIPTION OF THE INVENTION

The detailed description set forth below in connection with the appended drawings is intended as a description of several preferred embodiments of the apparatus of a multipurpose double-sided portable dry erase board.

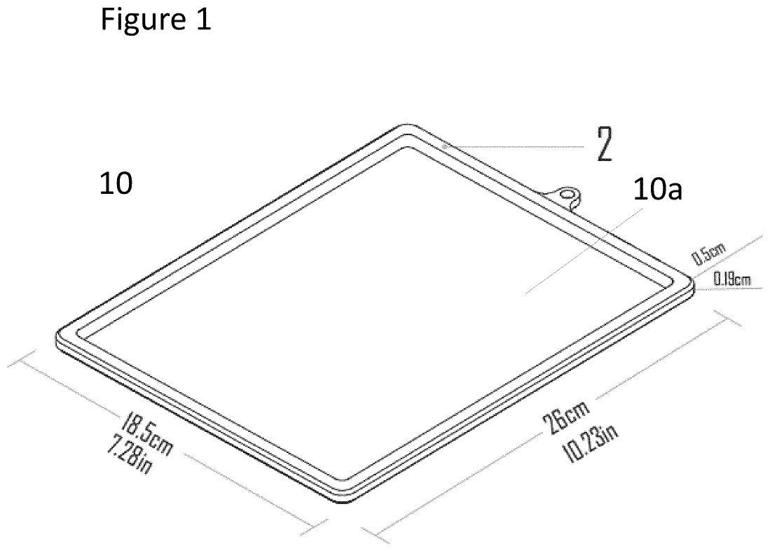

The following description particularly relates to the utilization of the instant device as a teaching tool. A preferred embodiment 10 of a double-sided portable dry erase board depicted in FIG. 1 comprises a front side 10a with a dry erase surface, a back side 10b with a dry erase surface, and a frame 2, wherein Easy-to-hand provides options for both vertical and horizontal placement of the board 10. In one embodiment, the double-sided dry erase board is 7.28 in W×10.23 in H×0.19 in thickness. (18.5 cm×26 cm).

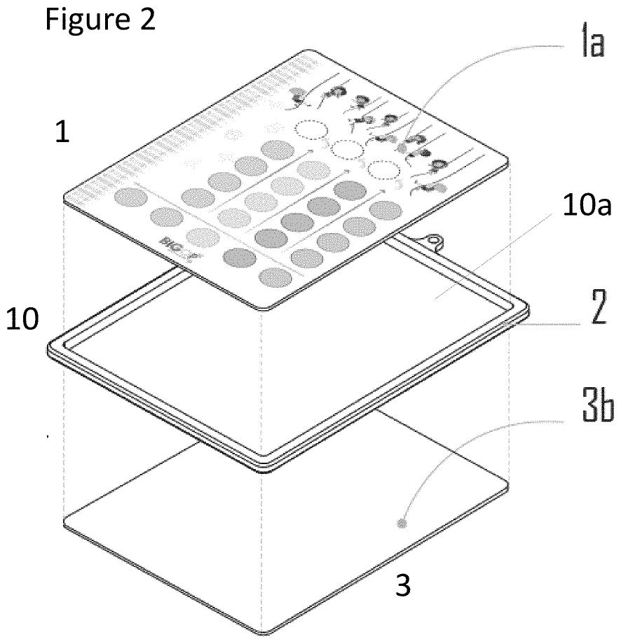

FIG. 2 illustrates the front face 1a of a didactic and colorful imprinted utility model template 1 over the front side 10a of the double-sided dry erase portable board 10, which allows a user to practice fundamental math such as addition and subtraction. The body of the board 10 is further provided with frame 2. In one preferred embodiment, the frame 2 is made of PVC for long durability. In addition, FIG. 2 also illustrates the back face 3b of a second didactic and colorful imprinted utility model template 3 over the back side 10b of the dry erase portable board 10, which allows the same user to practice other fundamental math such as multiplication. In one embodiment, the first template 1, the second template 3, and the frame 2 are curved.

The imprinted utility model template 1 in FIG. 2 has twenty-four symmetric graphic circles, distributed in six rows and five columns, wherein the circles are identified with their own colors and the board is utilized in the vertical direction. The first row from the bottom comprises five symmetric graphic circles in horizontal direction, which may be used to write the final result of the multiplication operation. On top of this row, a horizontal line is drawn. A second, a third, a fourth, and a fifth row comprises four symmetric graphic circles in each row. The sixth row consists of three symmetric dotted graphic circles. There are three vertical red lines as arrows dividing the columns. From right to left, as shown in FIG. 2, the imprinted utility model template has a green color in the first column, a pink color in the second column, a yellow color in the third column, and a blue color in the fourth and the fifth columns.

As shown in FIG. 2, the imprinted utility model dry erase board allows operations up to four digits in each of the fourth rows. Within the empty graphic circles of the second, third, and fourth row the digits may be marked with the dry erase ink pen. The imprinted blank dotted symmetric graphic circles on top of the utility model is designed to mark a remainder if needed. The sum of the total may be written below the red line with the dry erase ink pen.

For addition operations, for example, if a user would like to use the board to calculate 137 plus 935, he may mark the 3-digit numbers within the graphic circles of rows 2 and 3, and then apply the addition rule. Start with the first column with digit 7 and 5 and mark 2 as the first result inside the first circle from the right in the first row. The remainder is digit 1. A user may mark it in the dotted upper circle of the second column. The remainder will be used for the next operation if used. For the second column, the user may match the numbers 1 plus 3 plus 3 equals 7 and write down digit 7 in the second circle of the first row. In the third column, digits 1 plus 9 equals 10 and the user may write down digit 10 and use it to finish the third and fourth circles of the first row for a total of 1072.

For subtractions, operations up to 4 digits are allowed when using the utility model double-sided dry erase portable board. For example, for the subtraction of 65 minor 25, this operation uses two rows. A user may mark the digits in the circles of the second and the third rows. The first column shows 5 minus 5 equals 0. The user may mark down 0 (zero) as the first result inside the first graphic circle from right to left in the first row. The second column shows digits 6 minus 2 equals 4. Then, the user may mark down in the second circle of the first row to obtain the result of 40.

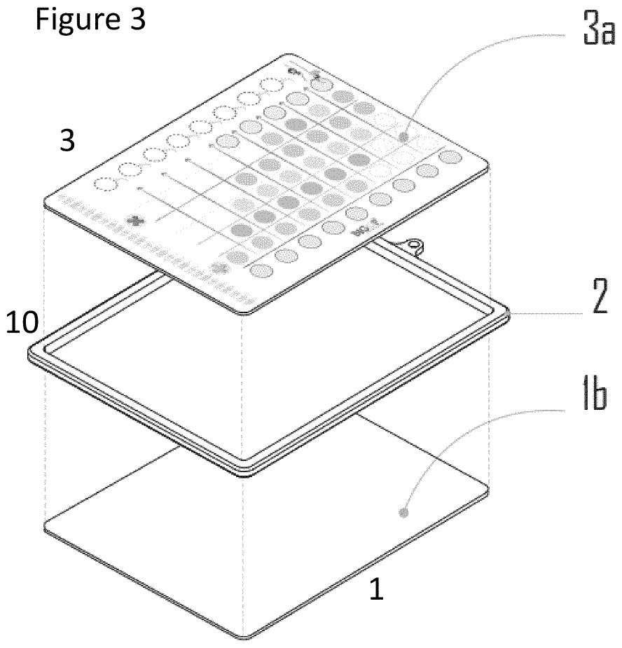

FIG. 3 illustrates the front face 3a of the second didactic and colorful imprinted utility model template 3 over the back side 10b of the double-sided dry erase portable board 10 as well as the back face 1b of the first didactic and colorful imprinted utility model template 1 over the front side 10a of the board 10.

For multiplications, the second imprinted utility model template is utilized in horizontal directions and up to five digits may be used. Any residue can be written in the imprinted blank symmetric dotted circles if needed. As shown in FIG. 3, the front face of the second imprinted utility model template has fifty-six symmetric graphic circles, distributed in eight rows and nine columns, start from right to the left. The first row from the bottom comprises nine blank symmetric graphic circles in horizontal direction, which will be used to write the final result of the multiplication operation. On top of this row, there is a horizontal line. The second row consists of nine symmetric graph circles, wherein the first, second and third symmetric circles are blank. The fourth, fifth, sixth, seventh, eighth and nine graphic circle are in blue. The nine circles embedded the sign plus. The third row comprises eight symmetric graph circles, wherein the first and second symmetric circles are blank, and the third, fourth, fifth, sixth, seventh, and eighth graphic circle are in pink color. The fourth row comprises seven symmetric graph circles, wherein the first symmetric circles are in the blank, and the second, third, fourth, fifth, sixth and seventh graphic circles are in yellow color. The fifty row comprises six symmetric graph circles, wherein the first, second, third, fourth, fifth, sixth graphic circle are in green color. The sixth row has four symmetric graphic circles, wherein the first circle has a green color, the second circle has a yellow color, the third circle has a pink color, and the fourth color has a blue color. The seventh row has five blank symmetric graph circles. The eighth row has eight blank symmetric dotted graphic circles.

In addition, there are eight vertical red lines as arrows dividing each column. The assignment of colored circles as green, yellow, pink, and blue within the utility model dry erase board depends on the number of digits in both the multiplier and the multiplying, which is designed to guide and give structure in each step in this mathematical process.

For example, to solve a multiplication of one hundred and twenty-two {122} by twenty-five {25}, a user may appoint the seventh row as multiplicand, write down one hundred and twenty-two {122}. Then, use the sixth row as multiplier and write down the digits twenty-five {25} with Digit five on the green circle of the first column and digit two on the yellow circle of the second column. The digit five {5} times two {2} equals ten {10}. The user may appoint the digit zero {0} on the green circle of the first column, over row five, appoint the digit one {1} as the remainder, in the first blank symmetry dotted circle of row 8 over the second column. However, the user must also add the number one {1}, appoint in the first blank symmetry dotted circle of row 8 over the second column. From there, the digit ten {10} plus digit one {1} equal eleven {11}, appoint the digit one {1} on the green circle of the second column, over row five, appoint the digit one {1} as the remainder, in the second blank symmetry dotted circle of row 8 over the third column.

Next, the digit five {5} times one {1} equals five {5}, where the number one {1} is appointed in the second blank symmetry dotted circle of row 8 over the third column. Then, the digit five {5} plus digit one {1} equals six {6}, where the digit six {6} is appointed on the green circle of the third column over row five. Then, the digit two {2} times two {2} equals four {4}, where digit four {4} is appointed inside of the yellow circle over row four {4} of the second column. Next, the digit two {2} times two {2} equals four {4}, where digit four {4} is appointed inside of the yellow circle over row four {4} of the third column. Next, digit two {2} times one {1} equals four {2}, where digit four {2} is appointed inside of the yellow circle over row four {4} of the fourth column.

Finally, the user may appoint Three Thousand Fifty {3050} as the result by following the staggered order as shown in FIG. 3, namely row four {4}, row five {5} and the staggered digits six hundred ten {610} and two hundred forty-four {244}.

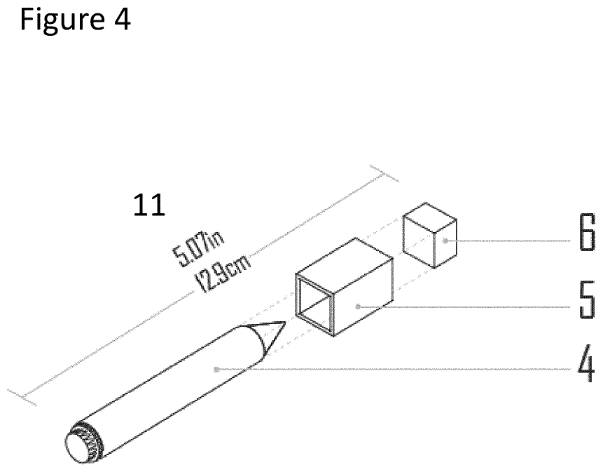

The instant device of the double-sided portable dry erase board also includes a dry erase ink pen 11 for writing, which comprises a dry erase pen body 4, a pen cap 5, and a wiper 6 that is disposed on the pen cap 5 as shown in FIG. 4. In one preferred embodiment, the dry erase ink pen 11 is a fine point ink pen, wherein the ink has low VOC that is recommended for all ages. Multi-Colored dry erase marker is also allowed to be used on the board. In another preferred embodiment, the pen cap 5 is provided with a mounting groove for mounting the wiper 6, and the wiper 6 is mounted to the mounting groove.

With the above scheme, the dry erase pen body is used for writing, and the cap is arranged to facilitate the cover to reduce the loss of ink, and the wiper is disposed on the cap to facilitate carrying, and at the same time, the numbers written on the double-sided portable dry erase board can be erased.

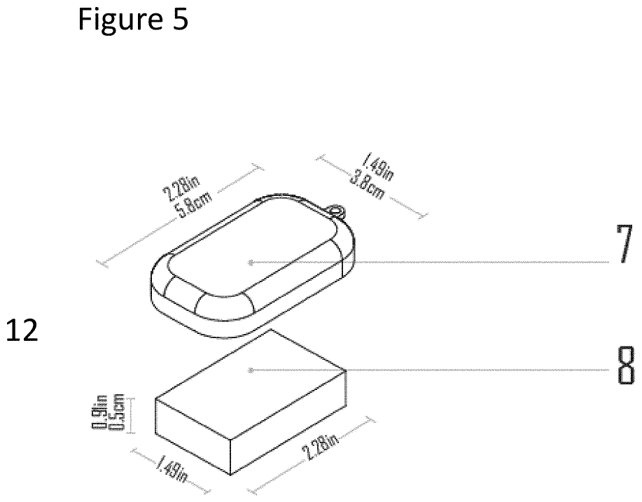

The instant device of the double-sided dry erase portable board further includes an eraser 12, which comprises a groove 7 and a wiping sponge 8 as shown in FIG. 5. In one embodiment, the eraser 12 is 2.28 in L×1.49 in W (5.8 cm×3.8 cm) and the wiping sponge 8 is 2.28 in L×1.49 in W×0.9 in in thickness.

What is claimed is:

1. A double-sided portable dry erase board comprises:
at least one imprinted utility model template on each side of the dry erase portable board;
a frame;
a dry erase ink pen; and
an eraser;
wherein the portable dry erase board can be placed vertically or horizontally.

2. The at least one imprinted utility model template of claim 1 comprises more than one imprinted polygon selected from the group consisting of regular and irregular shapes, wherein the polygons are distributed in such a way to direct the process for arithmetic operations.

3. The dry erase ink pen of claim 1 comprises a body, a cap, and a wiper, wherein a wiper is attached to one end of the pen.

4. The dry erase ink pen of claim 3 comprises a pen cap, wherein the cap has a mounting groove for mounting the wiper, and the wiper is mounted to the mounting groove.

5. The dry erase ink pen of claim 3 further comprises a magnetizer for easy attachment to the double-sided portable dry erase board.

6. The eraser of claim 1 comprises a magnetizer for easy attachment to the double-sided portable dry erase board.

7. A method for a basic arithmetic operation using a double-sided dry erase portable board comprises:
Selecting a proper imprinted utility model template;
marking the digits of a number within the polygons of a first row;
marking the digits of a second number within the polygons of a second row;
applying the rules of the arithmetic operation by starting with the first column from right to left in the first row of the imprinted utility model template; and
appointing numbers based on staggered order of each column from right to left to retrieve the answer to the arithmetic operation.
